(19) United States
(12) Patent Application Publication
(10) Pub. No.: US 2003/0108167 A1
(43) Pub. Date: Jun. 12, 2003

(54) Method and apparatus for using voice mail/phone system to print information

(76) Inventor: Genaro Antonio Fernandez, Jalisco (MX)

Correspondence Address: HEWLETT-PACKARD COMPANY, Intellectual Property Administration, P.O. Box 272400, Fort Collins, CO, 80527-2400, US

(21) Appl. No.: 10/004,806

(22) Filed: Dec. 7, 2001

(51) Int. Cl. H04M 11/00

(52) U.S. Cl. 379/88.13

(57) ABSTRACT

A voice mail system includes a voice mail controller which has software for interfacing with a user. The voice mail system retrieves locally stored voice mails and at the users request, prints the voice mails at a printer. The system can be adapted to retrieve Internet content, store the content and make hardcopies of the content. The system further comprises a telephone system or personal computer coupled to the voice mail controller. The printer device performs prescribed printing functions in response to commands issued by the voice mail controller and the user.

### FIELD OF THE INVENTION

This invention generally relates to a voice mail system and more particularly to a voice mail system which can be configured to print content downloaded from the Internet, e-mail messages and stored voice messages.

### BACKGROUND OF THE INVENTION

Voice mail systems (also termed voice messaging systems) attach to the telephone network, often via a public exchange (PBX) and are used to store messages from incoming calls when the intended recipient is absent or otherwise engaged. The intended recipient (a user) can then listen to their stored messages at some future time. A voice mail system is generally implemented either on special purpose computer hardware, or else on a standard computer workstation equipped with a suitable telephony interface. Such voice mail systems are ubiquitous in modern telephone systems.

With the growth of the Internet in recent years, there have been numerous attempts to provide voice mail access via the World Wide Web (WWW) client on the Internet. PCT/GB95/02009 and U.S. Pat. No. 6,181,781 B1 describe systems which allow uses to access voice mail systems via the Internet.

However, the above systems do not address generating hard copies of the messages stored in the voice mail system or allow a user to generate hard copies of particular Internet content accessed by via voice mail system.

A voice mail system which allows a user to store various types of content and print the content at the printer of their choosing is very convenient and provides for a more mobile work environment.

### SUMMARY OF THE INVENTION

In one respect, the invention is a voice mail system comprising a voice mail controller which includes software for interfacing with a user, a bridge circuit for bridging a first communications network with a second communications network, an Internet server coupled to the bridge circuit for communicating with other servers via the Internet and storing data retrieved from the Internet, and a printer device coupled to the Internet server for printing web content, stored e-mails and voice mails. The Internet server retrieves content from a web page and stores the pages locally. The system further comprises a telephone system or personal computer coupled to the voice mail controller. The printer device performs prescribed printing functions in response to commands issued by the voice mail controller. The controller further comprises a memory device, a processor and software operable to perform voice mail functions. Also, the bridge circuit is a POTS/PACKET bridge circuit. The printer device is accessed by using an IP address.

In a second respect, the invention is a voice mail system comprising a voice mail controller, a device coupled to the controller for bridging a voice network and a data network, a server coupled to the bridge for connecting with the Internet, such that the server retrieves a user's e-mail messages and a printer device coupled to the server which generates hard copies of the retrieved e-mail messages.

The voice mail system further comprises a computer or telephone coupled to the voice mail controller via a voice network, such that the user interfaces with the voice mail system via the computer or telephone. The printer device is identified by the voice mail system by its IP address and can be configured to print Internet content as well as, stored voice mail. The voice mail system contains a bridge circuit which is POTS to PACKET circuit. And the voice mail controller includes a memory, processor, voice mail software.

In a third respect, the invention is a voice mail system comprising a voice mail controller for communicating over a packet network. Also, an Internet server is coupled to the voice mail controller such that the Internet server communicates with other servers over a packet network and retrieves stored Internet information. Furthermore, a printer device which receives the Internet content and generates a hardcopy.

In a fourth respect, the invention is a voice mail system comprising a voice mail controller having a memory device for storing information, processor for controlling the other devices and voice mail software for interfacing with a user. And a printer device is coupled to the voice mail controller so that the printer generates hardcopies of selected voice mails.

In a fifth respect, the invention is a method for printing stored voice mail messages, e-mail messages and Internet content using a voice mail system. The user navigates the voice mail system and indicates to the system whether to access the stored voice mail message, e-mail message and the pre-selected web page(s).

The system then obtains either stored voice mail messages, e-mail messages, or accessing pre-selected web pages via the voice mail system and Internet server, and prints at least one of the stored voice mail messages, e-mail messages and pre-selected web pages at a selected printer device. The step of accessing further comprises connecting to the voice mail system via a telephone network using a telephone or computer. The step of navigating the voice mail system further includes the step of interacting with a software script, such that the software allows the voice mail system to prompt the user for specific actions. And bridging the voice network with a data network in such a manner as to allow the voice mail controller to communicate with an Internet server operating on a packet network.

In comparison to known prior art, certain embodiments of the invention are capable of achieving certain advantages, including some or all of the following: (1) more productive and efficient working environment; (2) the ability to print anywhere; and (3) saving time and effort of finding a computer to view content or messages. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

The invention is described in greater detail hereinafter, by way of example only, through description of a preferred embodiment thereof and with reference to the accompanying drawings in which:

FIG. 1 is a block diagram of an exemplary voice mail system employing principles of the invention;

FIG. 2 is a block diagram of a voice mail controller circuit employing principles of the invention;

FIG. 3 is a flow chart of the voice mail printing system employing principles of the invention;

FIG. 4 is a flow chart of the web page printing system employing principles of the invention; and

FIG. 5 is a flow chart of the e-mail printing system employing principles of the invention.

### DETAILED DESCRIPTION OF A PREFERRED EMBODIMENT

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

An embodiment of the invention as described in detail hereinafter provides for a voice mail system that allows a user to access various types of electronic media (e.g., voice mail messages, e-mail messages and web pages) via the voice mail system. The system also allows users to print the electronic media accessed by the voice mail system at a selected printer.

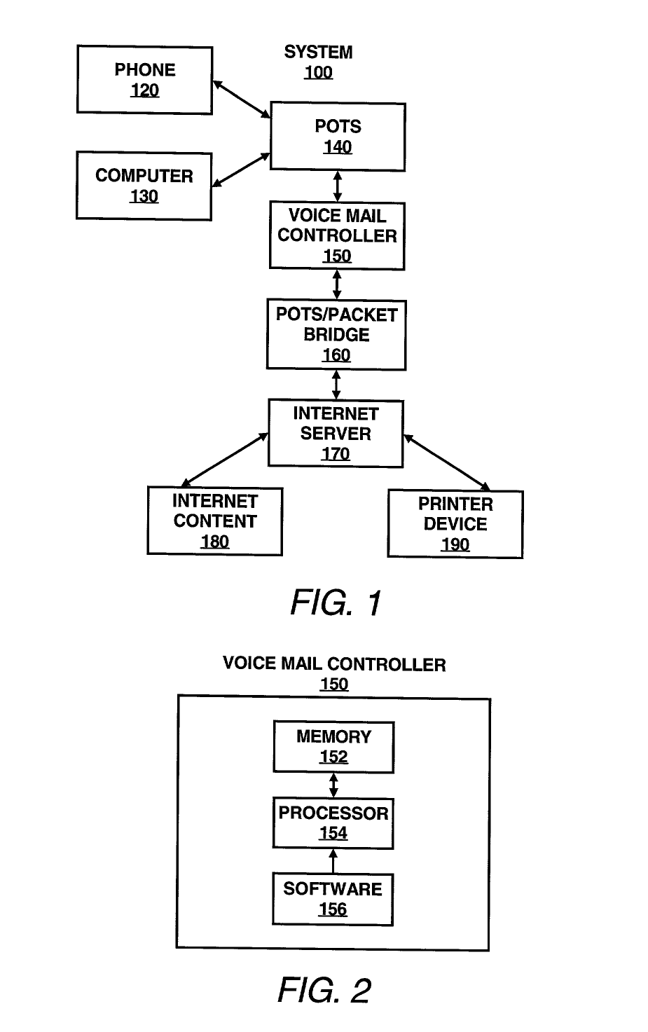

The voice mail system 100 is shown in block diagram form in FIG. 1. The system 100 includes a phone 120, computer 130, telephone network (plain-old telephone service, i.e., POTS) 140, voice mail controller 150, POTS/PACKET bridge 160, Internet Server 170, Internet content 180 and printer device 190.

The user accesses the voice mail system by either the phone 120 or computer 130. However, one of ordinary skill could envision an embodiment of the invention in which a user uses a wireless phone, laptop computer, a personal digital assistant (PDA), and the like, to connect to the voice mail system 100.

The phone 120 or computer 130 utilizes POTS 140 to connect to the voice mail controller 150. However, one of ordinary skill can envision an embodiment of the invention in which a local area network (LAN) intranet or some other type of network is used.

The voice mail controller 150 acts to control the functions of the voice mail system. The voice mail controller 150 will be explained in further detail with regards to FIG. 2.

The POTS/PACKET bridge circuit 160 allows the voice mail system 100 to communicate with another computer network, such as the Internet. The POTS/PACKET bridge circuit 160 converts the telephone voice signal into a data (packet) signal. The POTS/PACKET bridge circuit 160 can be a known network adaptor card or other known device. The POTS/PACKET bridge circuit 160 is coupled to the Internet Server 170. The POTS/PACKET bridge circuit is similar to the type shown in U.S. Patent No. 6,134,235 herein incorporated by reference.

The Internet server 170 is of a kind well known in the art. The Internet server 170 accesses content 180 via the Internet and communicates the content 180 back via the Internet server 170 and POTS/PACKET bridge circuit 160 to the voice mail controller 150.

The Internet server 170 is connected to a printer device 190. The printer device 190 can be located anywhere as long as it is connected by a phone or LAN. The printer device 190 receives the selected content or media and generates a hard copy of that content or media. One of ordinary skill can appreciate that the invention can be adapted to employ not only a printer device 190 but also, a digital copier, all-in-one printer, MFB (printer-scanner and fax) and networked fax.

The voice mail system 100 of the present invention can be implemented to access and print various types of information; voice mail, e-mail and Internet content. The user determines the particular type of information that is to be selected using the voice mail software 156 in the voice mail controller. The user configures the voice mail system 100 to define the information that is to be selected and stored by the system. The user can configure the system to access the Internet and store selected pages which can be printed at a later time.

The components of the voice mail controller 150 are illustrated in FIG. 2. The controller 150 includes a memory device 152, a processor 154 and voice mail software 156. The memory 152 stores the received information, the voice mail message, e-mail or Internet content. The received information is read from the memory to a printer device 190 for printing. The memory 152 stores pre-stored memory such as information input by the user or manufacture regarding the type of content that can be retrieved or the location of specific printers. The memory device 152 is of a kind known in the art.

The processor 154 is a microprocessor which controls the operations of the voice mail system 100. The processor 154 communicates with the various elements of the system and controls the operation of the voicemail software 156. The processor 154 operates on the retrieved Internet content or voice mail and in order to convert the retrieved information to a format suitable for printing. The processor 154 is of a type known in the art.

The voice mail software 156 and processor 154 are based on known voice processing systems, such as DirectTalk 6000™ described in U.S. Pat. No. 6,181,781 B1 herein incorporated by reference. The voice mail software 156 allows a user to interface with voice mail 100. The voice mail software 156 is responsive to user's commands and provides the appropriate feedback.

The hardware components of the controller 150 are a connector circuit (not shown) that connects to POTS 140 via known methods and a connector that connects to a bridge network 160.

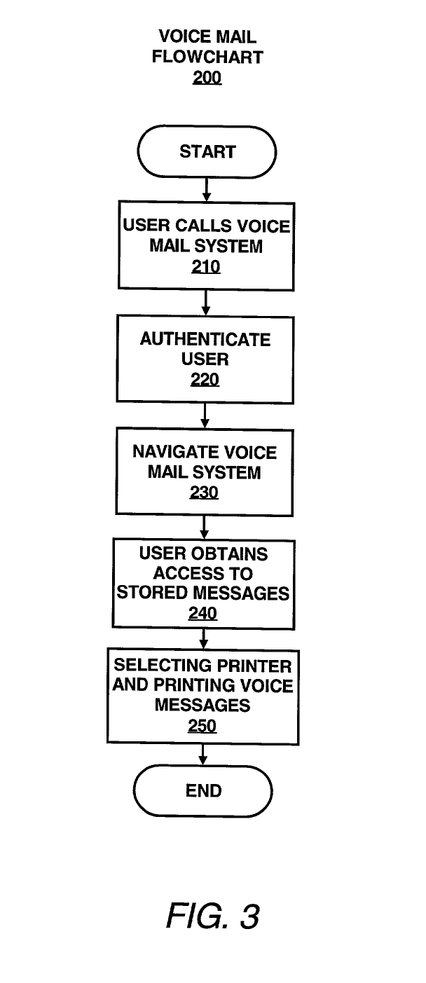

FIG. 3 illustrates a flow chart 200 showing exemplary steps for storing and printing the voice mail messages. At step 210, the user decides to access the voice mail system using either a phone or computer. As stated above, the system can be adapted to allow the user to use various different types of communication devices.

At step 220, the authentication process starts. The user is required to enter some form of authentication. The system can use numerous methods of authentication, such as entering a password, user-id or credit card number.

At step 230, the user accesses the voice mail software 156. As stated above, the voice mail software 156 can be of a type known in the art. Typically, the software program 156 allows users to access to various types of information based on responses users input to the system via the phone. The user interacts with the program using a voice interface that prompts the user for certain commands. In this way, the user can navigate the voice mail software 156 menus in step 230. For example, the voice mail software 156 will prompt the user on what particular content is accessed, and which content is to be printed and other known types of commands common to a voice mail software 156.

At step 240, the user directs the voice mail software 156 to retrieve stored voice messages. First, the user selects to access voice mail messages stored in the particular mailbox. The user follows the directions set out by the voice mail software 156 as a means to perform this task. For example, the voice mail software 156 may be configured to require user to press a particular button or series of buttons or speak a particular number or letter. Secondly, the voice mail software 156 allows the user to access messages stored in the users “mailbox”. The mailbox is a predetermined portion of memory either locally or remotely (on another server connected to the local server) in which the voice mail software stores electronic messages corresponding to the user. The voice mail controller 150 reads the electronic information from memory 152 and it transmitted to the user over the phone line. The system uses known techniques to carry out these functions.

At step 250, the user selects and configures a printer device 190 and prints the messages. The user is prompted to indicate whether the content should be printed. If the indication is yes, then the script continues with a prompt indicating where the user wanted the content to be printed. For example, the system would inquire as to whether the content should be printed from home, work, another local printer or another source. The user is further prompted to indicate whether a new printer is to be configured.

It is well known in the art to connect printers using the data networks such as the Internet. The present invention employs the use of the printer IP address as a means for identifying and communicating with a particular printer. The IP address is usually a 32-bit digit binary number that identifies each sender or receiver of information that is sent in packet form across the Internet. When the printer device 190 is selected, the user selects or inputs the IP address of the selected printer 190. Then, the Internet Protocol part of TCP/IP contained in the processor inputs IP address of the printer 190 in the request and communicates it to the selected printer 190 via the Internet Server 170. At the other end, the printer device 190 can see the IP address of the user and can respond by sending another message using the received IP address. The user can communicate with the printer device 190 in the above manner so as to allow the printer to be configured to the desires of the user. The printer device 190 can be configured in a manner known to the prior art. The user, then, indicates to the selected printer device 190 outputs a hardcopy of a particular voice-mail entry. The user navigates the voice mail script and indicates to the voice mail system 100 a desired to print a stored voice mail at the selected printer device 190. The user inputs or selected the IP address of the desired printer device 190. The voice mail controller 150 retrieves data stored in the memory device 152 that corresponds to the voice mail message that is to be printed. The IP address of the desired printer 190 and the retrieved data are transmitted to the printer device 190 via the POTS/PACKET Bridge 160 and the Internet Server 170.

The printer device 190 is adapted to receive the transmitted information and store it locally (not shown). The printer generates a hard copy of the selected voice mail in a manner known to one of ordinary skill and subsequently communicates that fact to the user.

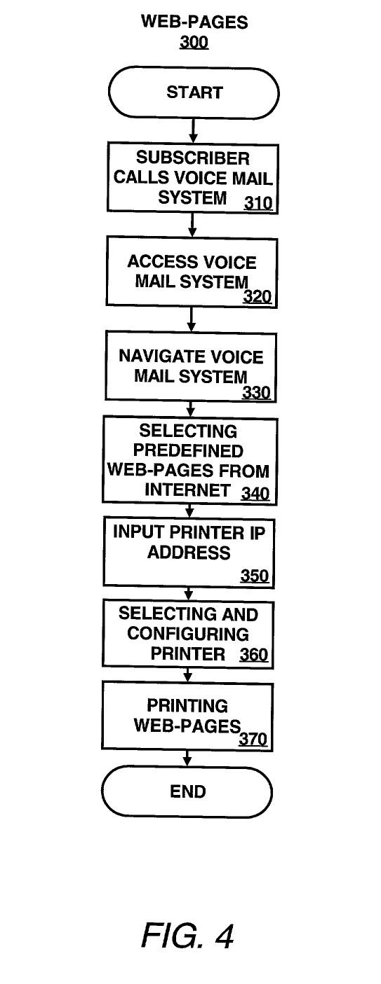

The embodiment of FIG. 4 illustrates a flow-chart showing a method of printing stored Internet content such Web pages.

In step 310, the user connects to the voice mail system. This could be accomplished via telephone, personal computer or personal digital assistant. In step 320, the user gains access to the voice mail system via the authentication process. In step 330, the user navigates the voice mail software scripts and selects to retrieve and print selected web pages. The user connects and navigates the voice mail system, for example, using the steps shown in FIG. 3.

In step 340, the user selects predefined content from the Internet. The content is typically pre-stored by the user either in a set-up mode or during an initialization phase. The voice mail system 100 allows users to access and store predefined web content 180 in an “off-line” capacity. Typically, the user is prompted to input a universal resource locator (URL) that identifies the location of the desired Internet content. The voice mail controller 150 transmits URL information to the Internet server 170 which retrieves the Internet content. When the user desired to access the information, the voice mail controller 150 connects to the Internet Server 170 via the POTS/PACKET BRIDGE 160 and accesses the Internet content 180. One of ordinary skill will understand that the content 180 itself can be print or audio. The user then accesses the stored Internet content 180 via the voice mail system software 156. The voice mail controller 150 will communicate with the Internet server 170. The voice mail controller 150 retrieves the stored Internet content 180 from the Internet server 170 and stores the Internet content 180 in the memory 152. The user indicates via the voice mail software 156 that a hard copy of the stored Internet content is to be produced.

In step 350, the user inputs or selects the IP address of the desired print device. The IP address is used by the voice mail controller processor 154 to institute communications with a selected printer device 190.

In step 360, once a connection is established between the printer device 190 and voice mail controller 150, the user can configure the printer device 190 to perform certain operations, such as stapling, collating, color printing, binding, etc as shown. When the user has configured the print device 190, the voice mail software 156 will prompt the user on whether the Internet content 180 should be printed.

In step 370, if the user indicates that the content should be printed, then the Internet content 180 is transmitted from the memory 152 in the voice mail controller 150 to the printer device 190. The printer device 190 then produces hard copies of the Internet content in a known fashion.

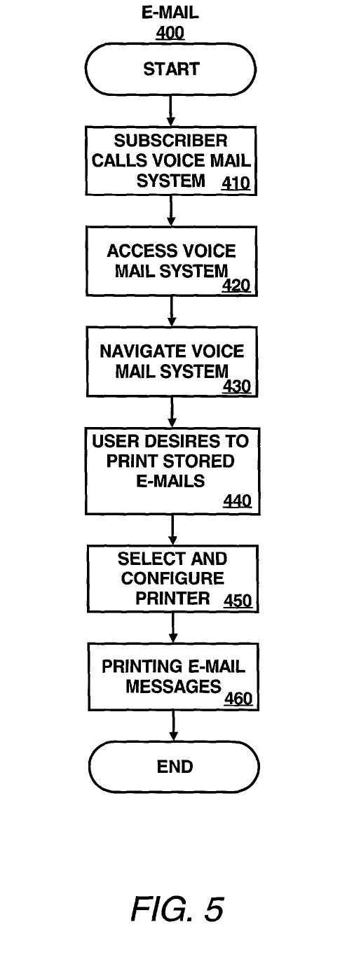

The embodiment of FIG. 5 illustrates a flow-chart 400 showing a method of printing stored e-mail messages. The method 400 permits a properly authorized user of a voice mail system to access and to print received e-mail messages stored on the user's e-mail server. The user first connects with the voice mail system, as shown in step 410. This can be accomplished by calling a specified phone number either using a telephone 120 or by connecting via modem connection with a computer 130. In step 420, the user accesses the voice mail system 100 and interacts with the voice mail software 156 stored in the voice mail controller 150. User access is granted based on an authorization process. The authorization process requires that the user input a password or other identifier, usually this is accomplished by requiring the user to input a phone number and a password. Once the user has been authorized, the voice mail software 156 provides the user with a number of options (such as listen to messages, changes messages, personal options, print message, print e-mails, download Internet content, print Internet content).

The user navigates the voice mail system as shown in step 430, by indicting the choice of options provided by pressing on a key pad or speaking the number which corresponds to the desired option. In this case, for example, the user would select the option to print e-mail messages.

In step 440, the voice mail system 100 determines that the user desires to print e-mail messages, the controller 150 communicates with the Internet server 170 in such a way as to direct the server 170 to access the user's e-mail server. Generally, e-mail is stored on the server of the ISP (Internet service provider) and is accessed via a password input by the user.

The user is asked to input the address(s) of the desired e-mail server. Specifically, the user is prompted to input the URL identifying the requested server in a set-up script designated by the voice mail software 156. The address is stored in the voice mail controller 150 and this information is communicated to the Internet server 170. The Internet server 170 communicates with the e-mail server corresponding to the URL. The server 170 communicates with the e-mail server and “logs on” by communicating the user's identification and a password.

The Internet server 170 will transmit the e-mail information to the voice mail controller 150. The voice mail controller 150 will store the e-mails locally in the memory 152. The user is notified by the voice mail software 156 that the e-mails stored in the e-mail server has been successfully transferred to the voice mail system and is available to be printed at a selected printer 190. One of ordinary skill in the art can appreciate that this operation can occur at predetermined intervals or specific times specified by the user.

Once the user is notified, in step 450, the voice mail software 156 prompts the user as to which printer device 190 the user desires to print the e-mail messages. The user, as stated above with regards to FIG. 4, then specifies the IP address of the desired printer. The IP address can be manually input into the system by the user using the keypad or selected from a list of stored IP addresses stored in the voice mail controller memory. Once the appropriate IP address is selected the voice mail system uses the selected address to connect to the printer device 190, as discussed above with regards to FIGS. 3.

In step 460, the printer device 190 generates hard copies of the selected e-mails.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A voice mail system comprising:
a voice mail controller connected to an Internet server;
a printer device coupled the Internet server for printing information received from the Internet server in response to the voice mail controller.

2. The system of claim 1, wherein said Internet server is coupled to a bridge circuit and a telephone network for communicating with other servers via the Internet and stores data retrieved from the Internet.

3. The system of claim 2, wherein said bridge circuit for bridges the telephone network with a second packet network.

4. The system of claim 3, wherein the bridge circuit is a POTS/PACKET bridge circuit.

5. The system of claim 1, wherein the voice mail controller further comprises a memory device, a processor and software operable to perform voice mail functions and including software for interfacing with a user, such that the memory device contains prestored information regarding the location of Internet content and printer information.

6. The system of claim 1, wherein the voice mail controller further comprises:
a memory device for storing information, a processor and voice mail software for interfacing with a user.

7. The system of claim 1, wherein the printer device is accessed by transmitting an IP address from the voice mail controller to the printer device and that address is pre-stored in the memory or input by the user.

8. The voice mail system of claim 1, wherein the information printed by the printer device is Internet content or voice mails.

9. A voice mail system comprising:
a voice mail controller;
a printer device coupled to the voice mail controller such that the printer generates hardcopies of selected voice mails in response to the voice mail controller.

10. The voice mail system of claim 9, wherein the voice mail controller has a memory device for storing information, processor and voice mail software for interfacing with a user.

11. The voice mail system of claim 9, wherein the printer device prints selected voice mails at the users request.

12. The voice mail system of claim 9, further comprising:
a computer or telephone connected to the voice mail controller via a telephone network such that the user controls voice mail system using the computer or telephone.

13. The voice mail system of claim 9, wherein the printer device is identified by the voice mail system by its IP address and that address is pre-stored in the memory or input by the user.

14. The voice mail system of claim 10, wherein the processor converts the retrieved information and converts it into a format suitable for printing.

15. The voice mail system of claim 14, wherein the memory device contains pre-stored information regarding voice mail mailbox location and printer information.

16. A method for printing stored e-mail messages and Internet content using a voice mail system comprising the steps of:
indicating via a voice mail controller that predetermined Internet content is to be printed;
receiving requested content;
storing the requested content retrieved by an Internet server; and
printing at a predetermined printer device the stored content in response to a voice mail controller.

17. The method of claim 16, further comprising the steps of:
pre-storing predetermined information regarding the content and printer; and
bridging the voice network with a data network in such a manner as to allow the voice mail controller to communicate with an Internet server operating on a packet network.

18. A method for printing stored voice messages using a voice mail system comprising the steps of:
indicating via a voice mail controller that predetermined a voice message is to be printed;
retrieving voice mail messages;
storing retrieved voice mail message in a voice mail controller; and
printing the stored voice mails at a predetermined printer.

19. The method of claim 11, further comprises the step of:
pre-storing information regarding voice mail mailbox location and printer information.

20. The method of claim 11, wherein the step of printing includes printing hardcopies of the preferred stored voice mails at the users request.
